(19) United States
(12) Patent Application Publication
(10) Pub. No.: US 2023/0230052 A1
(43) Pub. Date: Jul. 20, 2023

(54) GENERATING BLOCKCHAIN ADDRESSES

(71) Applicant: nChain Licensing AG, Zug (CH)

(72) Inventors: Jack Owen DAVIES, London (GB); Chloe TARTAN, London (GB); Alexander MACKAY, London (GB); Antoaneta SERGUIEVA, London (GB); Craig Steven WRIGHT, London (GB)

(21) Appl. No.: 18/009,319

(22) PCT Filed: May 12, 2021
(86) PCT No.: PCT/EP2021/062611

§ 371 Date: Dec. 8, 2022

(30) Foreign Application Priority Data
Jun. 12, 2020 (GB) 2008950.4

(51) Int. Cl. G06Q 20/02; G06Q 20/38

(52) U.S. Cl. CPC G06Q 20/02; G06Q 20/3829

(57) ABSTRACT

A computer-implemented method of generating a blockchain address based on a corresponding template output script of a blockchain transaction, wherein the blockchain address comprises a prefix component and a data component, and wherein the method is performed by a first party and comprises: generating a first blockchain address based on a first template output script, the first blockchain address comprising a first prefix component for identifying a first template output script, and a first data component representing one or more data items required to populate the first template output script; wherein the first prefix component is greater than one byte, and/or wherein the first data component is generated based on a plurality of data items required to populate the first template output script.

### CROSS REFERENCE TO RELATED APPLICATIONS

This application is the U.S. National Stage of International Application No. PCT/EP2021/062611 filed on May 12, 2021, which claims the benefit of United Kingdom Patent Application No. 2008950.4, filed on Jun. 12, 2020, the contents of which are incorporated herein by reference in their entireties.

### TECHNICAL FIELD

The present disclosure relates to methods for generating a blockchain address and for generating a blockchain transaction output script based on a blockchain address.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Previously, some blockchain networks restricted the inputs and outputs of transactions to a small number of “standard” transaction types, each with a specific scripting pattern. That is, for a transaction to be valid according to the consensus rules operated by the blockchain network, the transaction's inputs and outputs were required to conform to one of those standard transaction types.

Now, some or all of those restrictions have been removed, thus enabling the creation of customised transaction scripts, and allowing blockchain nodes to individually prescribe “policy rules” for the treatment of newly received transactions.

A challenge that comes with the loosing of restrictions on transaction type is the corresponding blockchain addresses that are used (e.g. by client applications applications) to encode output scripts, or rather the information for correctly generating an output script. Blockchain addresses provide a user-friendly experience for users of the blockchain wishing to assign digital assets to another user by replacing transaction scripts with comparatively small (e.g. 25-byte) strings. Blockchain addresses are not necessarily seen on the blockchain itself, but instead are implemented at the client application level. The most common transaction type, one of the of standard transactions, is known as a “pay-to-public-key-hash” (P2PKH) transaction. In a P2PKH transaction, digital assets are locked to an output script that specifies the recipient's public key hash. The corresponding P2PKH address is a string that uniquely represents that script.

However, a formal script-to-address map for “non-standard” or custom scripts does not currently exist. There is therefore a need to enables users to be able to generate blockchain addresses that encode (i.e. represent) non-standard transaction scripts. A first user can provide the generated address to a second user, allowing the second user to generate a corresponding output script.

According to one aspect disclosed herein, there is provided a computer-implemented method of generating a blockchain address based on a corresponding template output script of a blockchain transaction, wherein the blockchain address comprises a prefix component and a data component, and wherein the method is performed by a first party and comprises: generating a first blockchain address based on a first template output script, the first blockchain address comprising a first prefix component for identifying a first template output script, and a first data component representing one or more data items required to populate the first template output script; wherein the first prefix component is greater than one byte, and/or wherein the first data component is generated based on a plurality of data items required to populate the first template output script.

According to another aspect disclosed herein, there is provided a computer-implemented method of generating an output script of a blockchain transaction based on a corresponding blockchain address, wherein the blockchain address comprises a prefix component and a data component, and wherein the method is performed by a second party and comprises: generating a first output script of a first blockchain transaction, wherein the first output script is generated based on a first blockchain address, wherein the first blockchain address comprising a first prefix component identifying a first template output script, and a first data component representing one or more data items required to populate the first template output script, and wherein the first prefix component is greater than one byte, and/or wherein the first data component is generated based on a plurality of data items required to populate the first template output script.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain, and

FIG. 3 is a schematic block diagram of a system for generating a blockchain transaction based on a blockchain address.

### DETAILED DESCRIPTION OF EMBODIMENTS

Example System Overview

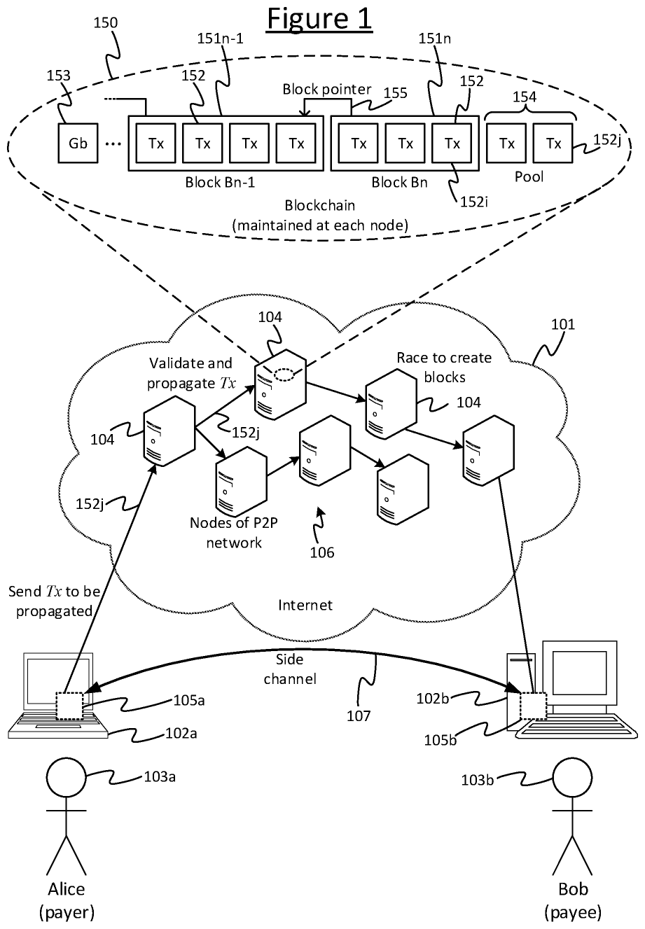

FIG. 1 shows an example system 100 for implementing a blockchain 150. The system 100 may comprise of a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

UTXO-Based Model

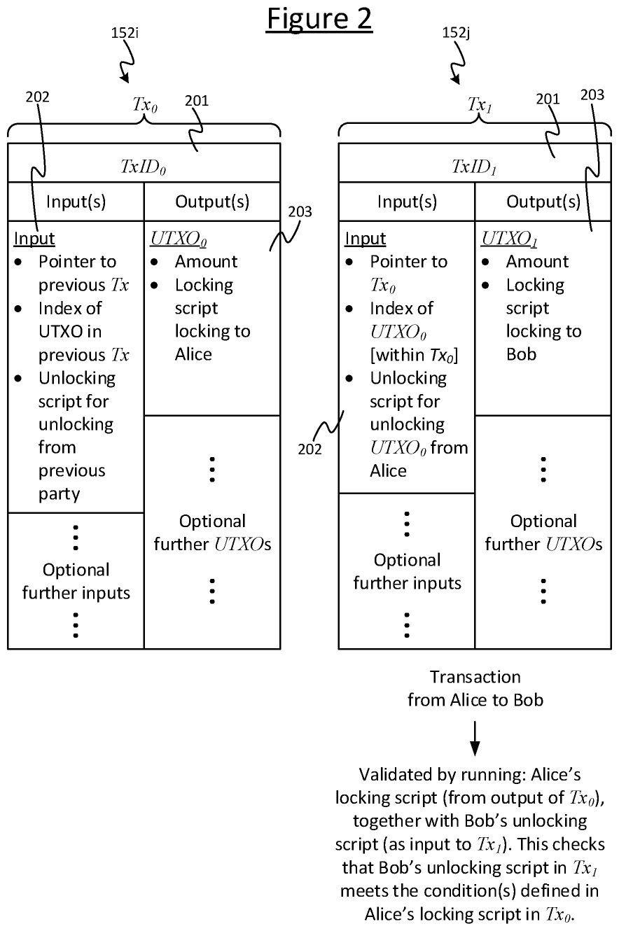

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

Preliminaries

Blockchain applications typically comprise (i.e. store) a collection of private keys that allows a user to transfer amounts of a digital asset and write data to the blockchain. There are many different implementations of client applications in the blockchain ecosystem. Design architecture for device-based applications can be thought of as existing on a scale between two types of trust model: server-client (custodial or part-custodial control of keys designed for better user experience and key backup) and peer-to-peer (decentralised control of keys with a higher onus of responsibility on the user).

Interoperability, in the context of client applications, is a measure of how transferable the information in one product is to other products or systems. Clients need to be interoperable so that users of the blockchain are not dependent on their particular client application provider to access their digital assets or blockchain data. For example, a user should be able to extract their private keys from one application and be able to import them into a new application without loss of assets/data.

Previous blockchain addresses—Typically an address is an alphanumeric identifier used to receive digital assets (e.g. payments) by encoding information related to specific blockchain script types. Some blockchain addresses can be 26-34 characters long and are base-58 encoded strings (i.e. alphanumeric characters excluding I,I,0 and 0 due to visual ambiguity). They are designed to improve safety and ease of use by converting the raw bytes from public keys and script into formatted strings.

There are three features of a conventional blockchain address:
Prefix—A single byte prepended to the beginning of an address string, which encodes the address type and network (e.g. Mainnet or Testnet) that the address is used on.
Hash digest—The data to which a locking script encumbers funds is hashed using SHA256+RIPEMD-160 in order to produce a unique 20-byte string. This also protects the public key from being transmitted in raw form prior to it being used to unlock a transaction output.
Checksum—A 4-byte checksum is added to the end of the address, ensuring that typing errors do not result in the incorrect conveyance of an address. If the hash of the prefix concatenated with the hash160 data does not match the checksum then the client application will alert the user that a mistake has been made.

Existing address types can be generalised as the following:

Address=Base58(<Prefix><H(Data)><Checksum>),

where the ‘Prefix’ is a sub-string that identifies a known locking script template, and ‘Data’ corresponds to the additional information that will itself, or some function of it, be used to populate the script template.

For instance, in the case of pay-to-public-key-hash (P2PKH) locking scripts, the prefix is assigned the number 1, which identifies (i.e. maps to) the following script template:

T_{P2PKH}=OP_DUP OP_HASH160<EMPTY>OP_EQUALVERIFY OP_CHECKSIG

where the empty data portion of script <EMPTY> is to be filled in with the RIPEMD-160 SHA256 hash of a public key, H₁₆₀(P). This means that a P2PKH address A_{P2PKH}(P), for a public key P, and the corresponding locking script LS_{P2PKH}(P) can be written as follows:

A_{P2PKH}(P)=Base58(<1><H₁₆₀(P)><Checksum>),

LS_{P2PKH}(P)=OP_DUP OP_HASH160<H₁₆₀(P)>OP_EQUALVERIFY OP_CHECKSIG.

The same process can be followed, but this time replacing the ‘Prefix’ with the number 3, which corresponds to a pay-to-script-hash (P2SH) locking script template, and the ‘Data’ with a serialized portion of script ‘SS’ to generate an address A_{P2SH}(SS) and corresponding locking script LS_{P2SH}(SS) as follows:

A_{P2SH}(SS)=Base58(<3><H₁₆₀(SS)><Checksum>),

LS_{P2SH}(SS)=OP_HASH160<H₁₆₀(SS)>OP_EQUAL.

where the standard script template T_{P2SH} for a P2SH locking script is used, in which the empty data portion of script <EMPTY> will correspond to the desired serialised script hash H₁₆₀(SS):

T_{P2SH}=OP_HASH160<EMPTY>OP_EQUAL.

These examples illustrate how each address can be mapped to a locking script, both of which include a hash of the ‘Data’ that is being used to populate a particular locking script template. This map can be visualised as:

A_{P2PKH}(P)⇄LS_{P2PKH}(P) P2PKH:

A_{P2SH}(P)⇄LS_{P2SH}(P). P2SH:

There are other standard output script templates, such as the multisignature template T_{MultiSig} and the data output template T_{OPRETURN}, as shown below:

T_{MultiSig}=<m=EMPTY><P₁=EMPTY> . . . <Pₙ=EMPTY><n=EMPTY>OP_CHECKMULTISIG,

T_{OPRETURN}=OP_FALSE OP_RETURN<EMPTY>.

However, there are no corresponding ‘addresses’ as such that are used to map to output scripts of this type.

A_{P2PKH} and A_{P2SH} are the only two standard address types in use on some blockchain networks at the time of writing, which therefore only require two corresponding script templates T_{P2PKH} and T_{P2SH} respectively, and these addresses can use single-character (1-byte) prefixes 1 and 3 respectively, because a space of 1 byte is sufficient to cater for just two address types.

Standard address types are currently used to map to very simple locking scripts, where in both cases the hashed data in the address (i.e. H₁₆₀(P) or H₁₆₀(SS)) can be inserted directly into the <EMPTY> script portion of the corresponding templates. This is only possible because:
The P2PKH case is extremely primitive and only caters for a simple locking script to be constructed; and
The P2SH case is used to accommodate all other possible scripts, but in such a way that the burden is on the recipient to provide these scripts in a subsequent unlocking script. This means that the creator of the locking script can simply represent complex scripts as a hash and directly insert this into the simple P2SH template.

There is in fact a bidirectional relationship, rather than just a one-way map, between existing address types and their corresponding locking scripts i.e. one can always be extracted directly from the other, without access to any external source of data, and vice versa.

This relationship can be written as:

A_{Type}(Data)⇄LS_{Type}(Data).

The bidirectional relationship between address and locking script is an important property of the existing address framework, which allows addresses used as a highly efficient means of communicating an entire locking script between peers in a way that is human-recognisable and able to be handled by users.

According to most blockchain protocols, each public key used to create a previous address must necessarily be derived from a unique private key. During address generation, the raw private key bytes are first prepended with a single byte (0x80 or 0xef) indicating whether the private keys are to be used to generate transactions on Mainnet or Testnet respectively. Checksums are then generated using the prefixed private key and appended to the end of the private key. Finally, the entire string is converted into 50-51 Base58 symbols and prepended with 5, L or K depending on whether the wallet function stores the public keys in compressed or uncompressed form. The resulting string is now in Wallet Import Format (WIF).

Public keys—A public key P is first generated from the private key s. This is done by multiplying the private key by the secp256k1 elliptic curve generator point G:

P=s·G.

The public key is then prepended with a single byte (0x02, 0x03, or 0x04) indicating whether the public key is stored in compressed or uncompressed format. The public key is then SHA256+RIPEMD160 hashed to produce a 20-byte string. A Network ID byte is prepended to the string (e.g. 0x00 for Mainnet). The string is double SHA256 hashed to create a checksum which is appended to the hash digest.

Blockchain Addresses

The current address framework used by the blockchain network caters for a limited number of different unlocking conditions. Whilst it is true that a number of scripting conditions can be encoded in P2SH locking scripts, the previous method of addressing was constrained by the reduction of locking scripts to two standard types: P2PKH and P2SH. This means that users were not free to create locking scripts outside of these two types.

The restrictions on locking scripts have now been relaxed on at least one blockchain network. However the restrictions may also be relaxed on other blockchain networks in the future, and in that case, the issues noted herein would then also apply to those networks. However, without establishing a new addressing protocol, the removal of the concept of “standard” transactions presents the following issues:
1. The 1-byte prefix space for an address does not cater for enough locking script templates to accommodate an expansive range of use cases and locking requirements.
2. Many locking script templates need to be populated with more than one <EMPTY> script portion. For instance, the m-of-n multisignature locking script template T_{MultiSig} would require the ‘data’ component of addresses to represent n different public keys, as well as the values of both m and n.

The present invention provides for a new addressing framework that allows for address generation to be applied to an unbounded variety of locking scripts in such a way that allows users, client applications and blockchain nodes to effectively transmit and handle them.

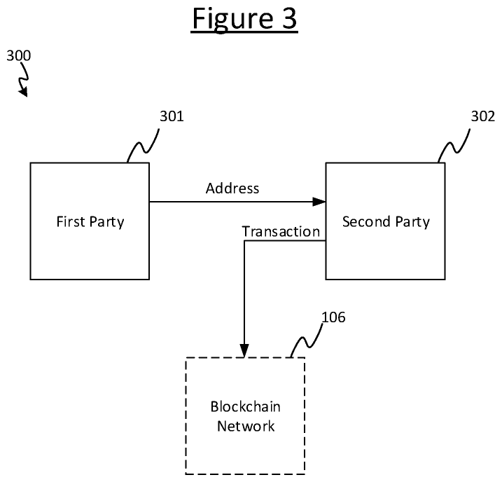

FIG. 3 illustrates an example system 300 for implementing embodiments of the present invention. The system 300 comprises a first party 301 configured to generate a blockchain address and a second party configured to generate an output (i.e. locking) script of a blockchain transaction. The system 300 may further comprise some or all of the blockchain network 106, i.e. one or more blockchain nodes 104. The second party 302 may submit a blockchain transaction comprising the generated output script to the blockchain network 106, or to another party (e.g. the first party 301) for that party to submit the transaction to the blockchain network 106.

The first party 301 and second party 302 each comprise respective computer equipment (not shown). It will be appreciated that any actions ascribed to either party 301, 302 apply to the respective computer equipment of that party 301, 302. As a particular example, the second party 302 may take the form of Alice 103a (e.g. a client application 105a operated by Alice 103a) and be configured to perform some or all of the actions described above as being associated with Alice 103a. Similarly, the first party 301 may take the form of Bob 103b (e.g. a client application 105b operated by Bob 103b) and be configured to perform some or all of the actions described above as being associated with Alice 103b. In this example, the second party 302 (Alice 103a) is transferring an amount of digital asset to the first party 301 (Bob 103b), but it will be appreciated that in other examples the first party 301 may transfer an amount of the digital asset to the second party 302. Note that in some embodiments the second party 302 and the first party 301 may in fact be the same entity. That is, the same entity may generate both the script and the corresponding address.

The first party 301 is configured to generate a blockchain address (e.g. a blockchain address associated with the first party 301) based on template output script. A template output script is an output script that requires populating with one or more data items. For instance, a template output script may comprise one or more operation codes (“opcodes”). Opcodes and their functions will be familiar to the skilled person.

The address generated by the first party 301 comprises at least a prefix component and a data component. The address may also comprise a checksum component, which will be discussed below. It will be appreciated that a component of an address is equivalent to a field of the address.

The prefix component identifies the template output script that is used to generate the blockchain address. That is, the prefix maps to the template output script. For instance, the prefix may act as a key in a key-value pair, with the value being the corresponding template output script. The prefix may be used to identify the template output script in a database, e.g. a look-up table, stored by the first party 301 and/or the second party 302. Additionally or alternatively, the database may be otherwise available to the first party 301 and/or the second party 302. For example, the database may be stored on the blockchain 150, or be otherwise found on the internet.

Note that the mapping need not necessarily be a unique mapping, although that it is not excluded. In other words, a given prefix may map to only one template script, or a prefix may map to several template scripts.

The data component represents the one or more data items required to populate the template output script in order to generate an output script of a blockchain transaction. Examples of data items include public keys, or data required to unlock and/or form the output script, or other data known to the first party 301.

According to the present invention, the prefix component has a size that may be greater than one byte. That is, the prefix component is not restricted to a single byte. In general, the prefix component may vary in size from two bytes to an upper limit according to data size restrictions enforced by any one of the first party 301, second party 302 or the blockchain network 106. In some embodiments, the prefix may be only one byte, which may be used to represent up to 256 template scripts.

Additionally or alternatively, the data component is generated based on a plurality of data components. That is, the data component is at least a function of multiple data items that are required to populate the template output script.

Once generated, the first party 301 may store the generated address, e.g. in their client application 105. Instead of or in addition to storing the address, the first party 301 may transmit the blockchain address to the second party 301, as shown in FIG. 3. The first party 301 may otherwise make the address available to the second party 302 for the second party 302 to obtain the address. For instance, the first party 301 may present the address to the second party 302, e.g. as a string, or as an optical representation of the address. As a particular example, the first party 301 may convert the address to a barcode or QR code and display the address (e.g. on a display screen) to the second party 302.

The prefix component may comprise one or more sub-components. For instance, a first sub-component of the prefix may comprise a human-readable string. A human-readable string is to be understood as series of letters and/or numbers than be interpreted by a user. In some examples, the human-readable string comprises only letters, or a combination of letters and numbers. For example, the human-readable string may comprise an identifier of the template output script on which the address is generated based on.

As another example, the prefix component may comprise a second sub-component generated based on the template output script. That is, the second sub-component may be generated by applying a function to the template output script, e.g. to encode or otherwise encrypt the template output script. The function may comprise one or more hash functions. For example, the template output script may be hashed and the hash result may form part or all of the second sub-component. In some examples, a function (e.g. hash function) is applied to the template output script to generator a result, and only part of that result forms the second sub-component. E.g. the first n leading digits of a hash digest of the template output script may form the second sub-component.

As another example, the prefix component may comprise a third component that comprises an identifier of a user and/or node of the blockchain network 106. For instance, the identifier may be a public key associated with the user and or a blockchain node 104. For instance, the node 104 may have indicated a willingness to publish a transaction comprising the template output script, e.g. ahead of other transactions.

The prefix component may comprise any combination of the first, second and third sub-components. Note that the terms “first”, “second”, and “third” are used merely as arbitrary labels and do not necessarily imply an ordering or a presence of one of the other sub-components. For instance, the prefix component may comprise the third sub-component independently of the first and/or second sub-components.

Similarly, the data component may comprise one or more sub-components, e.g. a first sub-component and/or a second sub-component. The first sub-component may comprise the one or more (e.g. the plurality of) data items required to populate the template output script. For instance, if the template output script is to be populated with a series of public keys, the first sub-component of the data component may comprise those public keys.

The second sub-component may be generated by applying a function to the one or more (e.g. plurality of) data items, e.g. to encode or otherwise encrypt the data items. The function applied to the data item(s) may or may not be the same function applied to the template output script to generate the second sub-component of the prefix component. Applying a function to the data item(s) may comprise hashing the data item(s).

The address generated by the first party 301 may comprise a checksum component. For instance, the checksum component may enable the first party 301 and/or second party 302 to verify that the address has been generated correctly, i.e. according to the address framework. The checksum may be generated based on some or all of the prefix component and/or some or all of the data component. As an additional or alternative option, the checksum component may be generated based on some or all of the data items required to populate the template output script.

The address may comprise one or more sub-components that indicate a that indicate the number of upcoming components and/or sub-components that make up the address, and/or the length of an upcoming component and/or sub-component of the address. For instance, a respective number of sub-components of the prefix components and/or data component may be indicated. As another example, a respective length of one or more of the prefix sub-components and/or a respective length of one or more of the data sub-components may be indicated. In a particular example, the address may comprise one or more variable integer (Varint) components that indicate the abovementioned number and/or length of sub-components.

In some examples, the blockchain address may be encoded using base58 encoding to omit: 0 (zero), O (capital o), I (capital i) and l (lower case L) as well as the non-alphanumeric characters + (plus) and / (slash).

The second party 302 is configured to generate an output script based on the blockchain address. The address may be obtained from the first party 301, e.g. the second party may receive the address as a QR code. The second party 302 may incorporate the output script in a blockchain transaction for assigning an amount of a digital asset to the first party 301.

The second party 302 may use the prefix component of the address to identify the template output script upon which the address has been generated. For instance, the second party 302 may store (e.g. in memory) one or more template output scripts, each being mapped to a prefix component or sub-component. The second party 302 may look-up the correct template output script using the prefix component or a sub-component thereof.

Alternatively, the template output script may be identified based on the data component, or based on data accompanying the address, e.g. a message from the first party 301.

The second party 302 may use the data component to populate the template output script. That is, the template output script comprises one or more fields that are unpopulated. In order to generate a complete output script those fields need to be populated with the data items represented by the data component.

Alternatively, some or all of the template output script may be populated based on the prefix component, or based on data accompanying the address, e.g. a message from the first party 301. That is, the first party 301 may send some or all of the data items to the second party 302.

The present invention provides for an addressing framework that aids the removal of the current notion of standard locking script types. The framework provides a process for creating a recognisable ‘address-type’ (A_{Type}) for any possible locking ‘script-type’ (LS_{Type}). This new framework enables some properties of previous addresses to be maintained, namely, that addresses may be human-recognisable, and the bidirectional relationship between addresses and scripts (A_{Type}(Data)⇄LS_{Type}(Data)).

The new framework for address generation may comprise three components:
1. An address prefix, which is used to identify the locking script template T_{Type} to which the address corresponds. This prefix is preferably six to eight bytes in length.
2. A data representation, R (Data), which is used to represent the ‘data’ that should be used to populate the address template T_{Type}.
3. A checksum (e.g. the leading four bytes of the hash of the rest of the address) which enables error-checking when generating an address.

These three components form the foundation of the new framework, which will generate addresses of the form:

Address=A_{Type}=Base58(<Prefix><R(Data)><Checksum>)

The key differentiators between the existing address framework and the new address framework are the following:
The prefix may be larger, in order to accommodate more possible address types.
The prefix can be chosen to contain human-readable (rather than just human-recognisable) data.
The prefix can be chosen in a flexible manner.
The representation of the data in the address can take multiple forms e.g. a hash, raw data, a collection of hashes.
Both of the prefix and data representation are configurable.

In essence, the framework allows for the advertisement (e.g. by nodes 104), exchange, and communication of locking script types that is both expansive enough to cope with the abolition of conventional scripting restrictions and also preserving the useful properties of existing address types. This framework is intended to be particularly useful in facilitating efficient user-to-user communication (via their respective client applications) now that users are free to create new script types that were previously deemed non-standard.

One of the configurable parts of the framework is the address prefix, which is defined as a string (e.g. of six bytes) that identifies the address type A_{Type} corresponding to a particular locking script template T_{Type}:

A_{Type}=Base58(<Prefix><R(Data)><Checksum>)

Varint encoding may be used so that the byte-lengths of the prefix, data and checksum are explicitly encoded into the string. Doing so facilitates variable prefix, data and checksum length addresses, thus provides greater flexibility for users.

There are multiple ways to generate this prefix, and the properties of the resulting address will depend on the method chosen. In general, there at least four broad options:

1. Using a human-readable string;

2. Using a hash of the script template;

3. Using a MinerID in addition to (1) or (2); or

4. Using a combination of (1), (2) and (3).

A simple way to assign prefixes to address types is to use a descriptive human-readable string that signifies the nature of the locking script template that is to be used. For instance, consider the pay-to-r-puzzle (P2RPH) template T_{P2RPH} shown below:

T_{P2RPH}=OP_DUP OP_3 OP_SPLIT OP_NIP OP_1 OP_SPLIT OP_SWAP OP_SPLIT OP_DROP OP_HASH160<EMPTY>OP_EQUALVERIFY OP_OVER OP_CHECKSIGVERIFY OP_CHECKSIG

An address for this template may be created by assigning the string “P2RPH” as the prefix itself <Prefix>=<P2RPH> and generating an address of the following form:

A_{P2RPH}(r)=Base58(<P2RPH><R(r)><Checksum>),

where the ‘Data’ that is used to populate the template locking script T_{P2RPH} is an integer r. Note that it is not stipulated how the value of r should be represented here as this will be discussed below.

The address A_{P2RPH}(r) can be mapped to the locking script L_{P2RPH}(r) in order to implement the new address framework for the case of P2RPH outputs. The corresponding script would be written as:

L_{P2RPH}(r)=OP_DUP OP_3OP_SPLIT OP_NIP OP_1OP_SPLIT OP_SWAP OP_SPLIT OP_DROP OP_HASH160<H(r)>OP_EQUALVERIFY OP_OVER OP_CHECKSIGVERIFY OP_CHECKSIG

The advantages of a human-readable prefix are that it allows users to interpret the nature of the locking script from the address, and improves usability for humans. Furthermore, a human-readable prefix protects against malware and helps to prevent outputs being locked to unspendable addresses.

An alternative way to create a prefix for a particular address type is to take the hash digest of the script template T_{Type} for the given locking script type. For example, again using the case of P2RPH, the prefix may be generated as <Prefix>=<L64[H(T_{P2RPH})]>, where L64[Data] is the first 8 bytes (64 bits) of data (the prefix byte length is chosen to be as compact as possible whilst ensuring a very low probability of hash collisions). This would allow the creation of an address for P2RPH output scripts of the form:

A_{P2RPH}(r)=Base58(<L64[H(T_{P2RPH})]><R(r)><Checksum>),

where, once more, it is not specified how exactly to represent the integer value r in the address.

The advantages of a script template hash prefix is that the prefix is inextricably linked to the actual form of the locking script, and it allows users to perform error-checking and version comparisons by comparing the hash of the expected locking script template with the leading bytes of the address.

In order to better facilitate specific blockchain nodes advertising their transaction validation policies (i.e. the configurable policy rules implemented by individual nodes), it is advantageous to link script template types to the MinerIDs (i.e. public keys) of specific nodes 104. If each node 104 has their own MinerID, which is itself a unique public key, each node 104 can define a set of address types they are willing to publish in a newly constructed block, forming a policy which client applications and payments service providers may query and watch when constructing transactions. In order to incorporate MinerID into address templates, the 4-byte prefix of the MinerID key may be combined with at least one of the previous methods in order to ensure that each address type and corresponding locking script template is uniquely defined within a single node's domain. This essentially means using a composite prefix made up of multiple components.

An example of addresses that may be generated for P2RPH locking scripts are as follows:

$${A}_{P 2 RPH} ( r ) = B ase 58 ( \underbrace{< {minerId}_{Coingeek} > < P 2 RPH >}_{Composite prefix} < R ( r ) > < Checksum > ) ; or$$

$${A}_{P 2 RPH} ( r ) = Base 58 ( \underbrace{< {minerId}_{MemPool} > < H ( {T}_{P 2 RPH} ) >}_{Composite prefix} < R ( r ) > < Checksum > ) .$$

However it is not excluded that a MinerID may be used independent of the previously mentioned prefix components.

The advantages of using a MinerID is that the prefix is inextricably linked to the actual form of the locking script, and it allows users to perform error-checking and version comparisons by comparing the hash of expected locking script template with the first 6-8 bytes of the address.

As each of the previous three methods for generating address prefixes have different properties and advantages, elements of all three may be used in a given address. For example, the following address could be a plausible example for a P2RPH output:

$${A}_{P 2 RPH} ( r ) = B ase 58 ( \underbrace{< {ID}_{Coingeek} > < P 2 RPH > < H ( {T}_{P 2 RPH} ) >}_{Composite prefix} < R ( r ) > < Checksum > ) .$$

In essence, a larger composite prefix encodes more information about each address type and corresponding locking script type.

The following discusses how to configure the data representation in the address

A_{Type}=Base58(<Prefix><R(Data)><Checksum>).

As for the prefix, there are multiple ways to configure this aspect of the address format, where each may be advantageous in different cases. Two approaches may be summarised as the following:

1. Using a function (e.g. hash) of the data;

2. Using the data itself directly in the address.

In general, ‘data’ in the context of addresses refer to the data that makes a particular locking script unique. In other words, where a script template may be used and reused multiple times, the <EMPTY> data fields in those templates are populated with a unique set of data elements that give the template meaning in a particular context.

For example, in the case of a pay-to-public-key-hash (P2PKH) locking script, the data would be the public key P that is being paid to by the locking script, since it is the particular choice of P that will differentiate that locking script from other locking scripts using the same template T_{P2PKH}.

There is a subtle distinction to be made here between the data and hashes of the data, as the blockchain network transitions from the simple existing scenarios of P2PKH and P2SH, where the only data type that needs to catered for are Data=P and Data=SS respectively. In these cases, the nature of P2PKH and P2SH are such that the output is paying to a hash, which is convenient and allows a user to represent the data as their respective hashes H(P) and H(SS) in both the address formats and locking scripts.

However, this is not so easily achieved for more complex scripts where a user may not wish to pay to a compact hash message digest; and/or where a user may wish to pay to multiple data elements e.g. a public key and some other secret.

This is one of the reasons why there is currently no standard ‘address’ format for pay-to-multisignature (P2MS) locking scripts, as the data used to populate the locking script includes the integer values m, n as well as the n public keys that are valid for signing. In this case, the output is not paying to simple message hashes, nor is it paying to a single data item. It is cases like these that the new addressing framework caters for.

The first option to consider is to use a function of the data as its representation in an address. For instance, in the case of P2MS with a large value of n, a hash function may be applied to the set of public keys in order to compactly represent them.

In this case, an address for a P2MS output may be generated as follows:

A_{MultiSig}=Base58(<Prefix><H(m∥n∥P₁∥P₂∥ . . . ∥Pₙ)><Checksum>).

The difference between this address and the example of a P2MS address that uses the full data in the address is that it compactly represents the full list of public keys P₁, P₂, . . . Pₙ as well as the parameters m, n using a single 20-byte hash value, rather than multiple 33-byte public keys and 32-byte integers, which makes for a far more manageable and user-friendly address format. This also enables an additional level of privacy in that the address may be constructed without all parties knowing which keys are involved in the locking script. However, this does have the trade-off that the address does not communicate all of the data required to populate the P2MS template, unless modified. This leaves two options:
(i) to modify the template script to which this address corresponds T_{MultiSig}→T′_{MultiSig} in order to pay to the combined public key hash; or
(ii) to provide the payer/payee with the raw form of the data (i.e. m∥n∥P₁∥P₂∥ . . . ∥Pₙ) via a separate channel (e.g. side channel 301) or message.

This means that using this method may break the bidirectional relationship between an address A_{MultiSig} and locking script L_{MultiSig} as it is possible to extract the address from the locking script but not the other way around, i.e.

A_{Type}(Data)←LS_{Type}(Data).

However, it should be noted that this is not necessarily true in all cases. In fact, in cases where the locking script explicitly does pay to a hash then using the hash of the data in the address does allow for the bidirectional relationship to be preserved.

The advantages of using a function of the data as representation is that it allows for a more compact representation of the locking script within the address, and using hash functions of the data allows for unique representation of the data that is used to populate a script template.

An alternative way to represent the data is to use the data itself by including it as part of the address. For example, in the case of a pay-to-multisignature (P2MS) locking script, m, n, P₁, P₂, . . . , Pₙ may be included as data in the P2MS address itself, as shown below

A_{MultiSig}=Base58(<Prefix><m∥n∥P₁∥P₂∥ . . . ∥Pₙ><Checksum>)

The address A_{MultiSig} here, assuming that the <Prefix> is chosen such that the template T_{MultiSig} can be identified, contains all the necessary information to construct a multisignature locking script L_{MultiSig} as shown below

LS_{MultiSig}=<m><P₁> . . . <Pₙ><n>OP_CHECKMULTISIG.

Using the data directly in this way allows the address to preserve the useful property noted earlier, namely that the address and locking script in this case have a bidirectional relationship and can therefore be extracted from one another, given knowledge of the template script T_{MultiSig}:

A_{MultiSig}(m,n,P₁,P₂,Pₙ)⇄LS_{MultiSig}(m,n,P₁,P₂, . . . Pₙ)

There are clearly many other use cases for which using the actual data as the representation of the data is applicable, and in many of these instances it is desirable to preserve the bidirectional relationship to allow users to communicate entire locking scripts succinctly.

One advantage of using the data as representation is that all the data that is required to populate a script template type can be extracted from the address. This means that addresses can continue to be used as a medium for conveying an entire script ‘to be paid to’, given that the mapping between address prefixes and script templates is publicly known and verifiable. Other advantages are that it retains bidirectional relationship: A_{Type}(Data)⇄LS_{Type}(Data) in majority of cases, the locking script can be fully communicated in a single message, it allows the data that populates a transaction to be error-checked (using the checksum in the address) for user error e.g. during manual input, and that the locking script data is transparent, which may give transacting parties confidence.

It is also possible that some cases may lend themselves to a combination of the methods of representing data in an address. For example, the following address format may be constructed for the same P2MS script as shown previously:

$${A}_{MultiSig} = B ase 58 ( < Prefix > \underbrace{< m > < n >}_{R ( Data ) = Data} \underbrace{< H ( ‖ {P}_{1} ‖ {P}_{2} ‖ … ‖ {P}_{n} ) >}_{R ( Data ) = H ( Data )} < Checksum > )$$

This address combines the use of the data itself (R(Data)=Data) and using a hash of the data (R(Data)=H (Data)) to preserve the privacy of the public keys while communicating how many parties are involved and the threshold number of signatories.

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of generating a blockchain address based on a corresponding template output script of a blockchain transaction, wherein the blockchain address comprises a prefix component and a data component, and wherein the method is performed by a first party and comprises:
generating a first blockchain address based on a first template output script, the first blockchain address comprising a first prefix component for identifying a first template output script, and a first data component representing one or more data items required to populate the first template output script;
wherein the first data component is generated based on a plurality of data items required to populate the first template output script.

Statement 2. The method of statement 1, comprising storing the first blockchain address and/or making the first blockchain address available to a second party.

Statement 3. The method of statement 2, wherein making the first blockchain address available to the second party comprises transmitting the first blockchain address to the second party.

Statement 4. The method of statement 2 or statement 3, wherein said storing and/or making available of the first blockchain address comprises representing the first blockchain address as a machine-readable optical label.

Statement 5. The method of any preceding statement, wherein the first data component is generated based on a plurality of data items required to populate the first template output script.

Statement 6. The method of any preceding statement, wherein the first prefix component comprises a first prefix sub-component comprising a human-readable string.

Statement 7. The method of any preceding statement, wherein the first prefix component comprises a second prefix sub-component generated by applying a function to the first template output script.

Statement 8. The method of statement 7, wherein applying the function to the first template output script comprises applying one or more hash functions to the first template output script.

Statement 9. The method of statement 7 or statement 8, wherein the second prefix sub-component comprises only part of a result of applying the function to the first template output script.

Statement 10. The method of any preceding statement, wherein the first prefix component comprises a third prefix sub-component, and wherein the third prefix sub-component comprises at least part of a public key.

Statement 11. The method of statement 10, wherein the public key is associated with a blockchain node.

In some examples, the first prefix component may comprise a combination of one, some or all of the first, second and third prefix sub-components.

Statement 12. The method of any preceding statement, wherein the first data component comprises a first data sub-component comprising at least one of the plurality of data items.

Statement 13. The method of statement 12, wherein the first data sub-component comprises the plurality of data items.

Statement 14. The method of any preceding statement, wherein the first data component comprises a second data sub-component generated by applying a function to the plurality of data items.

Statement 15. The method of statement 13 or statement 14, wherein applying the function to the plurality of data items comprises applying one or more hash functions to the plurality of data items.

Statement 16. The method of any preceding statement, wherein the first prefix component and/or the first data component comprises a respective sub-component indicating a respective length of the first prefix component and a respective length of the first data component.

Statement 17. The method of any preceding statement, wherein:
the first prefix component comprises one or more respective sub-components indicating a respective length of the first, second and/or third prefix sub-components; and/or
the first data component comprises one or more respective sub-components
indicating a respective length of the first and/or second data sub-components.

Statement 18. The method of any preceding statement, wherein the first blockchain address comprises a first checksum component.

Statement 19. The method of any preceding statement, wherein the first blockchain address is represented using base58 encoding.

Statement 20. The method of statement 2 or any statement dependent thereon, comprising transmitting the plurality of data items to the second party.

Statement 21. A computer-implemented method of generating an output script of a blockchain transaction based on a corresponding blockchain address, wherein the blockchain address comprises a prefix component and a data component, and wherein the method is performed by a second party and comprises:
generating a first output script of a first blockchain transaction, wherein the first output script is generated based on a first blockchain address, wherein the first blockchain address comprising a first prefix component identifying a first template output script, and a first data component representing one or more data items required to populate the first template output script, and
wherein the first data component is generated based on a plurality of data items required to populate the first template output script.

Statement 22. The method of statement 21, wherein the first prefix component is greater than one byte.

Statement 23. The method of statement 21 or statement 22, comprising obtaining the first blockchain address from a first party.

Statement 24. The method of any of statements 21 to 23, comprising identifying the first template output script from a plurality of candidate template output scripts based on the first prefix component.

Statement 25. The method of any of statements 21 to 24, comprising populating the first output script based on the one or more data items represented by the first data component.

Statement 26. The method of any of statements 21 to statement 25, comprising:
generating the first blockchain transaction; and
transmitting the first blockchain transaction to one or more blockchain nodes to be published on the blockchain.

Statement 27. Computer equipment comprising:
memory comprising one or more memory units; and
processing apparatus comprising one or more processing units, wherein the memory stores code arranged to run on the processing apparatus, the code being configured so as when on the processing apparatus to perform the method of any preceding statement.

Statement 28. A computer program embodied on computer-readable storage and configured so as, when run on the computer equipment of statement 26, to perform the method of any of statements 1 to 26.

According to another aspect disclosed herein, there may be provided a method comprising the actions of the first party and the second party.

According to another aspect disclosed herein, there may be provided a system comprising the computer equipment of the first party and the second party.

1. A computer-implemented method of generating a blockchain address based on a corresponding template output script of a blockchain transaction, wherein the blockchain address comprises a prefix component and a data component, and wherein the method is performed by a first party and comprises:
generating a first blockchain address based on a first template output script, the first blockchain address comprising a first prefix component for identifying the first template output script, and a first data component representing one or more data items required to populate the first template output script;
wherein the first data component is generated based on a plurality of data items required to populate the first template output script.

2. The method of claim 1, comprising storing the first blockchain address and/or making the first blockchain address available to a second party.

3. The method of claim 2, wherein making the first blockchain address available to the second party comprises transmitting the first blockchain address to the second party.

4. The method of claim 2, wherein said storing and/or making available of the first blockchain address comprises representing the first blockchain address as a machine-readable optical label.

5. (canceled)

6. The method of claim 1, wherein the first prefix component comprises a first prefix sub-component comprising a human-readable string.

7. The method of claim 1, wherein the first prefix component comprises a second prefix sub-component generated by applying a function to the first template output script.

8. The method of claim 7, wherein applying the function to the first template output script comprises applying one or more hash functions to the first template output script.

9. The method of claim 8, wherein the second prefix sub-component comprises only part of a result of applying the function to the first template output script.

10. The method of claim 1, wherein the first prefix component comprises a third prefix sub-component, and wherein the third prefix sub-component comprises at least part of a public key.

11. (canceled)

12. The method of claim 1, wherein the first data component comprises a first data sub-component comprising at least one of the plurality of data items.

13. The method of claim 12, wherein the first data sub-component comprises the plurality of data items.

14. The method of claim 1, wherein the first data component comprises a second data sub-component generated by applying a function to the plurality of data items.

15. The method of claim 14, wherein applying the function to the plurality of data items comprises applying one or more hash functions to the plurality of data items.

16. The method of claim 1, wherein the first prefix component and/or the first data component comprises a respective sub-component indicating a respective length of the first prefix component and a respective length of the first data component.

17. The method of claim 1, wherein:
the first prefix component comprises one or more respective sub-components indicating a respective length of the first prefix sub-components; and/or
the first data component comprises the one or more respective sub-components indicating a respective length of the first data components.

18. The method of claim 1, wherein the first blockchain address comprises a first checksum component.

19. (canceled)

20. The method of claim 2, comprising transmitting the plurality of data items to the second party.

21. A computer-implemented method of generating an output script of a blockchain transaction based on a corresponding blockchain address, wherein the blockchain address comprises a prefix component and a data component, and wherein the method is performed by a second party and comprises:
generating a first output script of a first blockchain transaction, wherein the first output script is generated based on a first blockchain address, wherein the first blockchain address comprising a first prefix component identifying a first template output script, and a first data component representing one or more data items required to populate the first template output script, and
wherein the first data component is generated based on a plurality of data items required to populate the first template output script.

22-26. (canceled)

27. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of generating a blockchain address based on a corresponding template output script of a blockchain transaction, wherein the blockchain address comprises a prefix component and a data component, and wherein the method is performed by a first party and comprises:
generating a first blockchain address based on a first template output script, the first blockchain address comprising a first prefix component for identifying a first template output script, and a first data component representing one or more data items required to populate the first template output script;
wherein the first data component is generated based on a plurality of data items required to populate the first template output script.

28. A computer program embodied on a non-transitory computer-readable storage medium and configured so as when run on computer equipment, the computer equipment performs a method of generating a blockchain address based on a corresponding template output script of a blockchain transaction, wherein the blockchain address comprises a prefix component and a data component, and wherein the method is performed by a first party and comprises:
generating a first blockchain address based on a first template output script, the first blockchain address comprising a first prefix component for identifying the first template output script, and a first data component representing one or more data items required to populate the first template output script;
wherein the first data component is generated based on a plurality of data items required to populate the first template output script.
